(19) United States
(12) Patent Application Publication
(10) Pub. No.: US 2019/0332506 A1
(43) Pub. Date: Oct. 31, 2019

(54) CONTROLLER AND FUNCTION TESTING METHOD

(71) Applicant: DENSO TEN Limited, Kobe-shi (JP)

(72) Inventors: Masanori AKAZA, Kobe-shi (JP); Akiyoshi TANAKA, Kobe-shi (JP)

(73) Assignee: DENSO TEN Limited, Kobe-shi (JP)

(21) Appl. No.: 16/269,852

(22) Filed: Feb. 7, 2019

(30) Foreign Application Priority Data
Apr. 25, 2018 (JP) 2018-084201

(51) Int. Cl. G06F 11/26; G06F 11/14; G06F 12/14; H04L 12/40

(52) U.S. Cl. CPC G06F 11/26; G06F 11/1438; H04L 2012/40215; H04L 12/40; G06F 12/1441

(57) ABSTRACT

A controller includes: a main processing unit that executes a program; and a monitoring unit that monitors a signal, output from the main processing unit, to reset the main processing unit when detecting an abnormality in the main processing unit. The main processing unit includes: a detection unit that resets the main processing unit when detecting an incorrect access of another program to a protection target region of the program; a first testing unit that intentionally executes the incorrect access to the protection target region to test whether the main processing unit is reset by the detection unit; and a second testing unit that intentionally outputs a signal indicating an abnormal state to the monitoring unit to test whether the main processing unit is reset by the monitoring unit. When detecting the incorrect access, the detection unit causes the second testing unit to intentionally output the signal.

### CROSS-REFERENCE TO RELATED APPLICATION

This application is based upon and claims the benefit of priority of the prior Japanese Patent Application No. 2018-084201, filed on Apr. 25, 2018, the entire contents of which are incorporated herein by reference.

### FIELD

The embodiment discussed herein is directed to a controller and a function testing method.

### BACKGROUND

Conventionally, there has been known an Electronic Control Unit (ECU) that is provided in a vehicle so as to electronically control various systems of the vehicle such as an engine, a transmission, and a car navigation. In the ECU, a built-in micro controller (hereinafter, may be referred to as “microcomputer”) executes control programs so as to realize assigned various functions.

The control programs are able to be roughly divided into (i) “functional-safety application” such as a drive-system controlling program, which is required to have an extremely-high safety, and (ii) “non-functional-safety application” that does not affect traveling of the vehicle even if the application does not operate.

These applications simultaneously operate in one ECU in some cases, thus the ECU is provided with, for example, a Memory Protection Unit (MPU), and prevents, by using this MPU, the non-functional-safety application from incorrectly accessing a protected region used by the functional-safety application so as to ensure the safety of the vehicle (see Japanese Laid-open Patent Publication No. 2013-232151, for example).

Note that, if the MPU has an abnormality, this safety is not ensured, and thus the ECU executes an intentional incorrect access on the protected region at its start-up, for example, so as to perform an MPU-function test for recognizing whether a memory-protection-offence exception is correctly generated.

Similarly, in order to ensure the safety, the ECU includes a monitor Integrated Circuit (IC) that monitors whether or not the microcomputer normally operates. The monitor IC includes, for example, a power source IC. As a monitoring system using the monitor IC, there have been known a watchdog counter (hereinafter, may be referred to as “WDC”) monitoring system that monitors an interval between pulses of WDC signals that are output from the microcomputer, and a question-answering system that periodically exchanges “question” and “answer” between the monitor IC and the microcomputer by using serial communication, for example.

When an interval between pulses of the WDC signals or an answer of the microcomputer delays, or an evaluated answer is not an expected one, the monitor IC determines that an operation abnormality occurs in the microcomputer, so as to reset the microcomputer, for example.

When there presents an abnormality in the monitor IC, the above-mentioned safety is not able to be ensured, and thus the ECU transmits, at its start-up or the like, an intentional reset request to the monitor IC so as to execute an external monitor-function test for determining whether the microcomputer is normally reset from an external device (namely, monitor IC).

However, the above-mentioned conventional technology has room for improvement in improving the reliability of the function test so as to enhance the safety.

Specifically, in the MPU-function test, for example, the ECU expands in some cases, in a mounted Random Access Memory (RAM), information for determining whether an intentional incorrect access or an unintentional incorrect access. However, there presents possibility that the information expanded in the RAM has RAM garbling due to a reset of the microcomputer, for example, thereby leading to having an abnormal value.

If the expanded information has an abnormal value, there presents possibility that the ECU erroneously determines an intentional incorrect access during an MPU-function test even when an unintentional incorrect access to a protected region occurs during a normal control that is not the function test.

### SUMMARY

A controller according to an embodiment includes a main processing unit and a monitoring unit. The main processing unit executes a program. The monitoring unit monitors a signal, output from the main processing unit, so as to reset the main processing unit when detecting an abnormality in the main processing unit. The main processing unit includes a detection unit, a first testing unit, and a second testing unit. The detection unit resets, when detecting an incorrect access, the main processing unit. The incorrect access is an access, to a protection target region that is dedicated to a specific program, of another program other than the specific program. The first testing unit intentionally executes the incorrect access to the protection target region so as to test whether or not the main processing unit is reset by the detection unit. The second testing unit intentionally outputs a signal indicating an abnormal state to the monitoring unit so as to test whether or not the main processing unit is reset by the monitoring unit. When detecting the incorrect access, the detection unit causes the second testing unit to intentionally output, to the monitoring unit, a signal indicating an abnormal state.

### BRIEF DESCRIPTION OF DRAWINGS

A more complete appreciation of the present disclosure and many of the attendant advantages thereof will be readily obtained as the same becomes better understood by reference to the following detailed description when considered in connection with the accompanying drawings, wherein:

FIG. 1A is a diagram illustrating an outline of an on-vehicle system;

FIG. 1B is a diagram illustrating an outline of a function testing method according to a comparison example;

FIG. 1C is a diagram illustrating an outline of the function testing method according to the comparison example;

FIG. 1D is a diagram illustrating an outline of a function testing method according to an embodiment;

FIG. 2 is a block diagram illustrating an Electronic Control Unit (ECU) according to the embodiment;

FIG. 3A is a timing diagram illustrating the function testing method according to the embodiment;

FIG. 3B is a timing diagram illustrating the function testing method according to the embodiment; and

FIG. 4 is a flowchart illustrating a processing procedure to be executed by the ECU according to the embodiment.

### DESCRIPTION OF EMBODIMENT

Hereinafter, an embodiment of a controller and a function testing method according to the present application will be described in detail with reference to the accompanying drawings. The present disclosure is not limited to the embodiment described in the following.

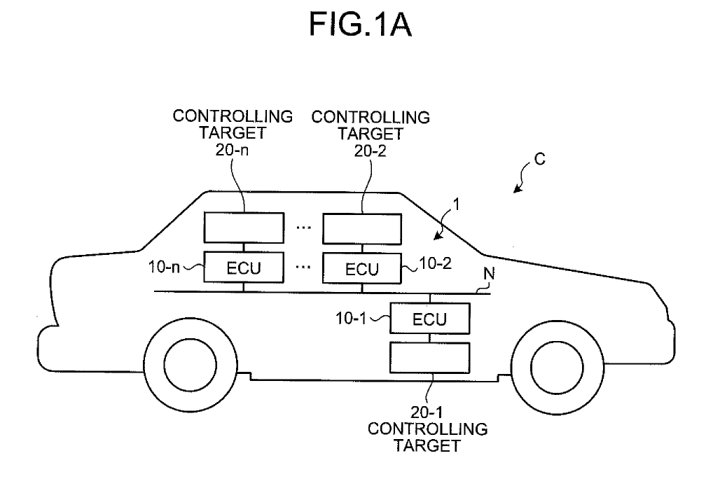

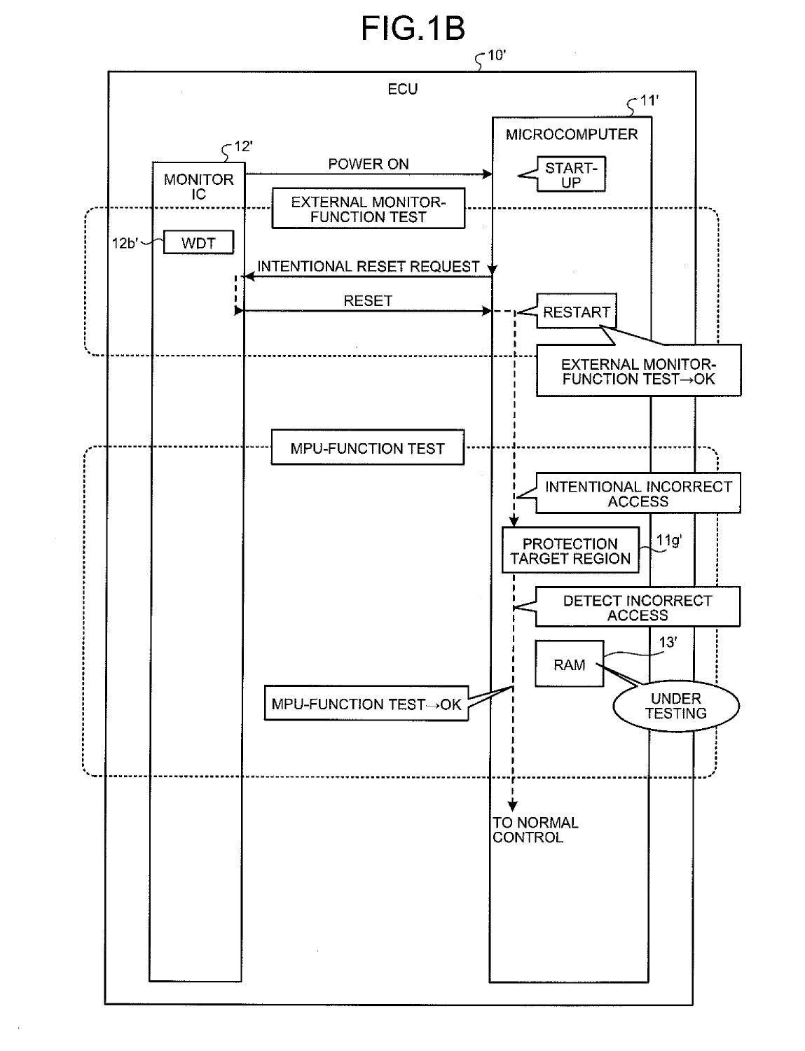

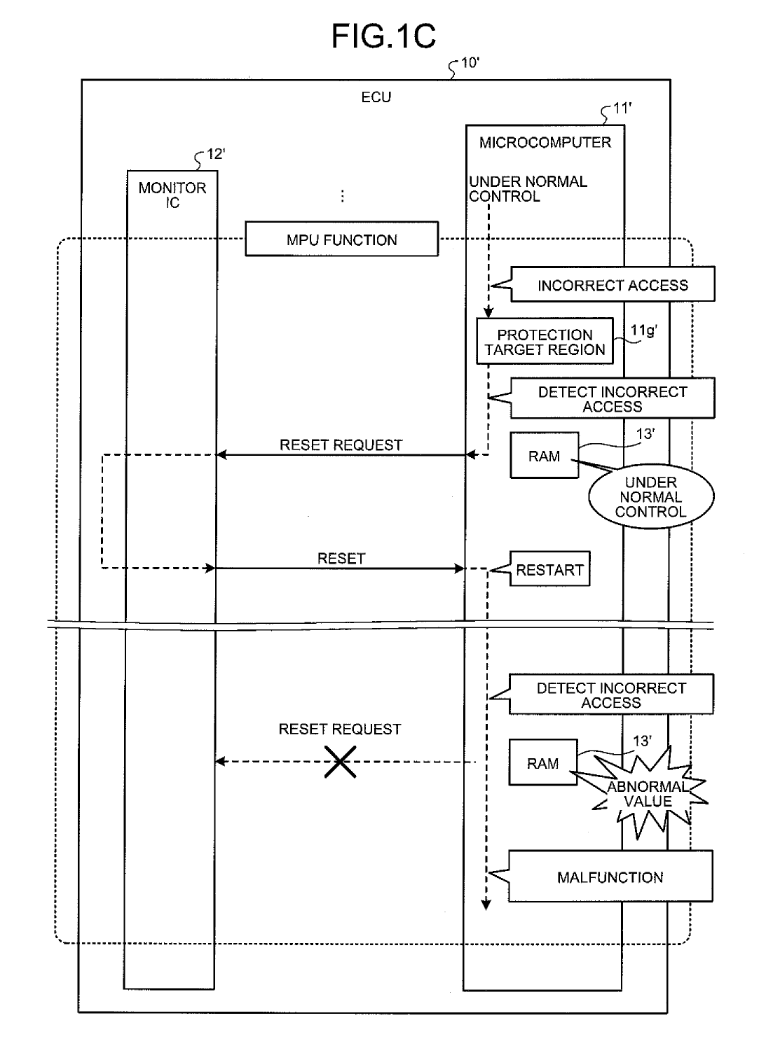

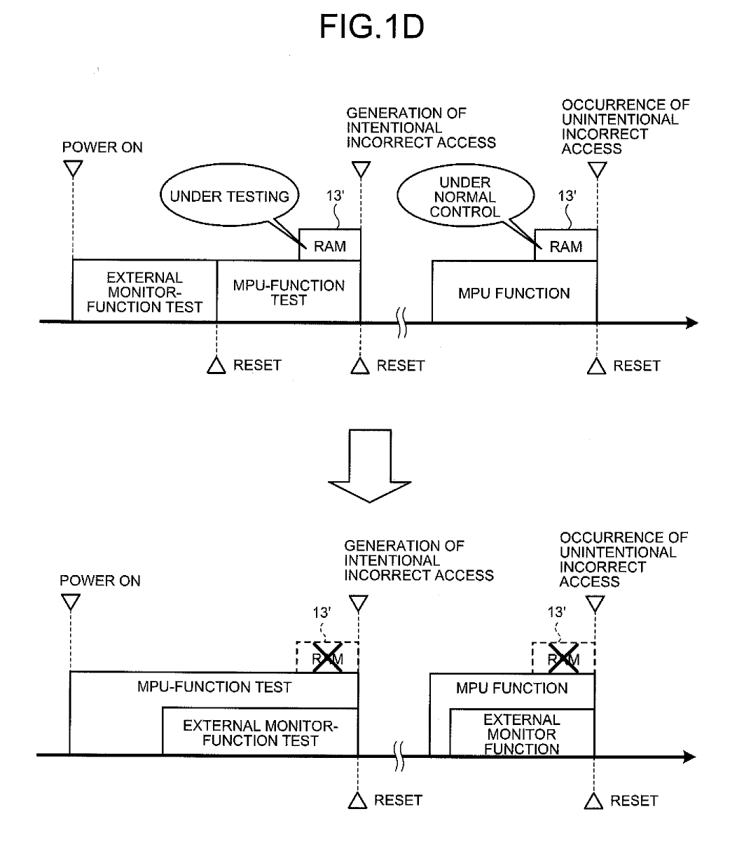

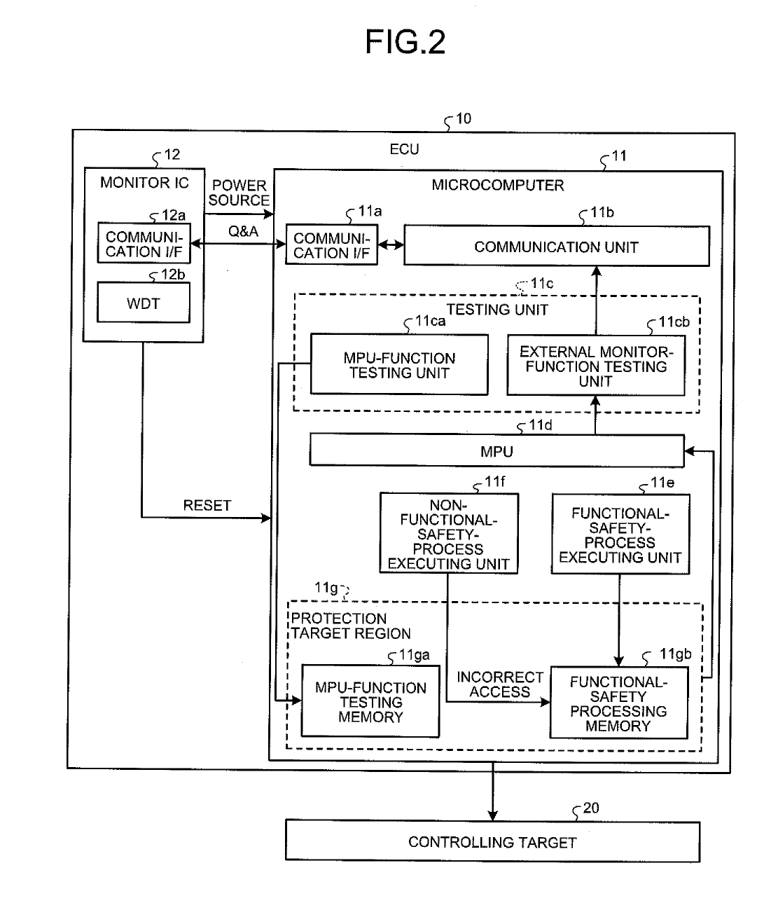

Hereinafter, an outline of a function testing method according to the present embodiment will be explained with reference to FIGS. 1A to 1D, and then an ECU 10 (corresponding to one example of “controller”) for which the function testing method according to the present embodiment is employed will be explained with reference to FIGS. 2 to 4.

The outline of the function testing method according to the present embodiment will be explained with reference to FIGS. 1A to 1D. FIG. 1A is a diagram illustrating an outline of an on-vehicle system 1. FIGS. 1B and 1C are diagrams illustrating an outline of a function testing method according to a comparison example. FIG. 1D is a diagram illustrating an outline of the function testing method according to the present embodiment. In FIG. 1A, “n” is an arbitrary natural number that is equal to or more than “1”. In FIGS. 1B and 1C, in order to distinguish from the present embodiment, reference symbols of the configuration elements are provided with “′”.

As illustrated in FIG. 1A, a vehicle C includes the on-vehicle system 1. The on-vehicle system 1 includes a plurality of ECUs 10-1 to 10-n. The ECUs 10-1 to 10-n are communicably connected to one another by a network N such as a Controller Area Network (CAN), and each of the ECUs 10-1 to 10-n executes a control program so as to electronically control corresponding one of controlling targets 20-1 to 20-n. The controlling targets 20-1 to 20-n are various systems such as an engine, a transmission, a brake, and a car navigation device.

As illustrated in FIG. 1B, an ECU 10′ of a conventional configuration according to the comparison example includes a microcomputer 11′ and a monitor IC 12′. The microcomputer 11′ is a main processing unit of each of the ECUs 10′, which executes control programs so as to realize various functions assigned to the corresponding ECU 10′.

The monitor IC 12′ supplies a power source to the microcomputer 11′. The monitor IC 12′ monitors an operation state of the microcomputer 11′ by using a question-answering system. In other words, the monitor IC 12′ transmits a question, and the microcomputer 11′ transmits an answer in response to the question. These are exchanged by the serial communication using a Serial Peripheral Interface (SPI), for example.

The monitor IC 12′ evaluates a received answer that is transmitted from the microcomputer 11′. Such an exchange is periodically repeated, when an evaluated result is NG, the monitor IC 12′ resets the microcomputer 11′ in response to this result, for example.

When an instantaneous noise causes a communication abnormality in transmitting an answer, for example, and communication does not succeed in transmitting the answer; the monitor IC 12′ waits for receiving the answer by using a watchdog timer (WDT) 12b′ provided therein.

When determining a time-out by using the WDT 12b′, the monitor IC 12′ resets the microcomputer 11′, for example. These are “external monitoring function” using the monitor IC 12′.

The microcomputer 11′ includes a not-illustrated MPU (corresponding to MPU 11d illustrated in FIG. 2), a protection target region 11g′, and an RAM 13′.

The MPU detects an incorrect access, performed by a non-functional-safety application, to the protection target region 11g′ of a memory that is used by a functional-safety application. When detecting the incorrect access, the MPU generates a memory-protection-offence exception.

When this memory-protection-offence exception is generated, the microcomputer 11′ resets the microcomputer 11′, for example. These are “MPU function” using the MPU.

In order to ensure the safety by using the “external monitoring function” and the “MPU function”, it becomes a premise that the monitor IC 12′ and the MPU are to have no abnormality. Thus, the ECU 10′ executes “external monitor-function test” and “MPU-function test” at its start-up, for example.

Specifically, as illustrated in FIG. 1B, when the monitor IC 12′ is turned into “power ON” and the microcomputer 11′ turned into “start-up”, the ECU 10′ first executes an “external monitor-function test”. In the “external monitor-function test”, the microcomputer 11′ transmits, to the monitor IC 12′, an “intentional reset request” that is using a question-answering system. The “intentional reset request” is an intentional incorrect answer, for example.

When the monitor IC 12′ is normal, the microcomputer 11′ is to be “reset” in response to this “intentional reset request”. When the microcomputer 11′ normally “restarts”, “external monitor-function test→OK” is determined.

Next, the ECU 10′ executes a “MPU-function test”. In the “MPU-function test”, an “intentional incorrect access” is executed on the protection target region 11g′. In a case where the “intentional incorrect access” is executed, when the MPU is normal, the “incorrect access is detected” in response thereto. Information indicating “under testing” is stored in the RAM 13′ during the “MPU-function test”, when the intentional incorrect access is correctly detected during a period of this “under testing”, the microcomputer 11′ determines “MPU-function test→OK”.

The microcomputer 11′ shifts “to normal control”. In this case, a process (for example, “reset request”) in response to the intentional incorrect access is not executed.

As illustrated in FIG. 1C, in a state where the microcomputer 11′ is “under normal control”, when the “MPU function” executes an “incorrect access” on the protection target region 11g′ and the MPU is normal, an “incorrect access is detected” in response thereto.

In a state under normal control, the RAM 13′ stores therein information indicating “under normal control”, when an incorrect access is detected in the state “under normal control”, the microcomputer 11′ executes a process corresponding thereto. For example, the microcomputer 11′ transmits, as a corresponding process, a “reset request” to the monitor IC 12′, and the monitor IC 12′ “resets” the microcomputer 11′ so as to “restart” the microcomputer 11′.

Meanwhile, as illustrated in FIG. 1C, in a state under normal control, there presents possibility that an “abnormal value” is stored in the RAM 13′ due to RAM garbling and the like. For example, there may be present possibility that “under normal control” is rewritten as “under testing”. In this case, if the MPU “detects incorrect access”, for example, a “reset request” that is the above-mentioned corresponding process is not executed because the state is “under testing”, and thus there presents possibility that the microcomputer 11′ has a “malfunction”.

Therefore, the function testing method according to the present embodiment is executed by a procedure for executing a reset request when an incorrect access is detected “under testing”, without referring to the RAM 13′.

In the function testing method according to the present embodiment, this reset request when the incorrect access is detected is executed by a procedure common to the “external monitor-function test” and “external monitoring function”.

Specifically, as illustrated in an upper part of FIG. 1D, in the function testing method according to the comparison example, when “power ON” is performed, the “external monitor-function test” is performed to execute a first “reset”, and then the “MPU-function test” is performed to execute a second “reset” on the basis of “generation of intentional incorrect access” and “under testing” of the RAM 13′.

Under the normal control, “reset” is executed on the basis of the “occurrence of unintentional incorrect access” of the “MPU function” and the “under normal control” of the RAM 13′.

On the other hand, as illustrated in a lower part of FIG. 1D, in the function testing method according to the present embodiment, when “power ON” is performed, the “MPU-function test” is first executed, and a reset request in response to the “occurrence of unintentional incorrect access” is to be executed by the “external monitor-function test”, without reference to the RAM 13′.

Under the normal control, a reset request in response to the “occurrence of unintentional incorrect access” of the “MPU function” is executed by the “external monitoring function”, without reference to the RAM 13′.

Thus, by employing the function testing method according to the present embodiment, the “MPU-function test” and the “external monitor-function test” are able to be executed without reference to the RAM 13′, which has possibility of storing therein an abnormal value, so that it is possible to improve the reliability of the function tests so as to enhance the safety.

Furthermore, by employing the function testing method according to the present embodiment, the “MPU-function test” and the “external monitor-function test” are able to be executed via one reset, so that it is possible to shorten a time interval for the ECU 10 to shift from a power ON to a normal control.

Furthermore, by employing the function testing method according to the present embodiment, similarly to the case of the function test, the reset request is executed without reference to the RAM 13′ even under the normal control, so that it is possible to enhance the safety.

Hereinafter, the ECU 10 for which the above-mentioned function testing method is employed will be specifically explained.

FIG. 2 is a block diagram illustrating the ECU 10 according to the present embodiment. In FIG. 2, configuration elements needed for describing features of the present embodiment are illustrated, and description of general configuration elements is omitted.

In other words, the configuration elements illustrated in FIG. 2 are functionally conceptual, and thus they are not to be physically configured as illustrated in the drawings. Specific forms of distribution and integration of the configuration elements of the illustrated devices are not limited to those illustrated in the drawings, and all or some of the devices can be configured by separating or integrating the apparatus functionally or physically in any unit, according to various types of loads, the status of use, etc.

As illustrated in FIG. 2, the ECU 10 includes a microcomputer 11 and a monitor IC 12. The monitor IC 12 will be first explained. The monitor IC 12 includes a communication interface (I/F) 12a and a WDT 12b.

The monitor IC 12 is a power source IC so as to supply a power source to the microcomputer 11. The communication I/F 12a is an SPI, for example, so as to exchange a question and an answer of the question-answering system with the microcomputer 11. The WDT 12b is a watchdog timer as described above.

As described above, the monitor IC 12 resets the microcomputer 11 on the basis of an incorrect answer transmitted from the microcomputer 11, a time-out of the WDT 12b, etc. Therefore, the microcomputer 11 is able to perform an intentional reset request caused by the intentional incorrect answer and/or the intentional delay.

Next, the microcomputer 11 will be explained. The microcomputer 11 includes a communication I/F 11a, a communication unit 11b, a testing unit 11c, an MPU 11d, a functional-safety-process executing unit 11e, a non-functional-safety-process executing unit 11f, and a protection target region 11g.

The testing unit 11c includes an MPU-function testing unit 11ca and an external monitor-function testing unit 11cb. The protection target region 11g includes an MPU-function testing memory 11ga and a functional-safety processing memory 11gb. The microcomputer 11 controls a controlling target 20.

The communication I/F 11a is an SPI, for example, so as to exchange a question and an answer of the question-answering system with the communication I/F 12a. The communication unit 11b receives, via the communication I/F 11a, a question transmitted from the monitor IC 12, and generates an answer in response to the question so as to output the generated answer to the monitor IC 12. For example, in the external monitor-function test, the communication unit 11b generates an intentional incorrect answer so as to output the generated intentional incorrect answer as an intentional reset request.

The testing unit 11c executes each function test of the MPU-function test and the external monitor-function test. The MPU-function testing unit 11ca executes the MPU-function test. In other words, when a power source is supplied to the microcomputer 11 so as to start up the microcomputer 11, the MPU-function testing unit 11ca executes the MPU-function test in advance of the external monitor-function test.

Specifically, the MPU-function testing unit 11ca accesses the MPU-function testing memory 11ga included in the protection target region 11g of the MPU 11d, so as to execute an intentional incorrect access.

The external monitor-function testing unit 11cb executes an external monitor-function test. Specifically, when receiving an interrupt of a memory-protection-offence exception transmitted from the MPU 11d, which is caused by the intentional incorrect access of the MPU-function testing unit 11ca, the external monitor-function testing unit 11cb causes the communication unit 11b to generate an intentional reset request and to output the generated intentional reset request.

The MPU 11d is a memory protection unit so as to detect an incorrect access to the protection target region 11g. When detecting this incorrect access, the MPU 11d causes the external monitor-function testing unit 11cb to generate an interrupt of the memory-protection-offence exception.

The functional-safety-process executing unit 11e executes, under a normal control of the microcomputer 11, a functional-safety application. In this case, the functional-safety-process executing unit 11e forwards the processing while accessing the functional-safety processing memory 11gb of the protection target region 11g. The functional-safety processing memory 11gb is a memory space dedicated to the functional-safety-process executing unit 11e, and is protected by the MPU 11d.

The non-functional-safety-process executing unit 11f executes, under a normal control, a non-functional-safety application while accessing a non-functional-safety processing memory (not illustrated) other than the protection target region 11g. When this non-functional-safety-process executing unit 11f incorrectly accesses the functional-safety processing memory 11gb of the protection target region 11g regardless of intentional or unintentional, the MPU 11d detects this incorrect access so as to cause the external monitor-function testing unit 11cb to generate an interrupt of a memory-protection-offence exception. The protection target region 11g is a memory space to be protected by the MPU 11d.

The microcomputer 11 includes: a computer including, for example, a Central Processing Unit (CPU), a Read Only Memory (ROM), a Random Access Memory (RAM), a Hard Disk Drive (HDD), and an input/output port; and various circuits.

For example, the CPU of the computer reads and executes a program stored in the ROM so as to function as any of the communication I/F 11a, the communication unit 11b, the testing unit 11c, the MPU 11d, the functional-safety-process executing unit 11e, and the non-functional-safety-process executing unit 11f of the microcomputer 11.

Moreover, all or a part of the communication I/F 11a, the communication unit 11b, the testing unit 11c, the MPU 11d, the functional-safety-process executing unit 11e, and the non-functional-safety-process executing unit 11f of the microcomputer 11 may be constituted of hardware such as an Application Specific Integrated Circuit (ASIC) and a Field Programmable Gate Array (FPGA).

A memory (not illustrated) and the protection target region 11g (MPU-function testing memory 11ga and functional-safety processing memory 11gb) correspond to the RAM and/or the HDD, for example. The RAM and the HDD are capable of storing therein information on various programs. The microcomputer 11 may acquire the above-mentioned programs and various kinds of information via another computer, connected to the microcomputer 11, via a wired/wireless network or a portable recording medium.

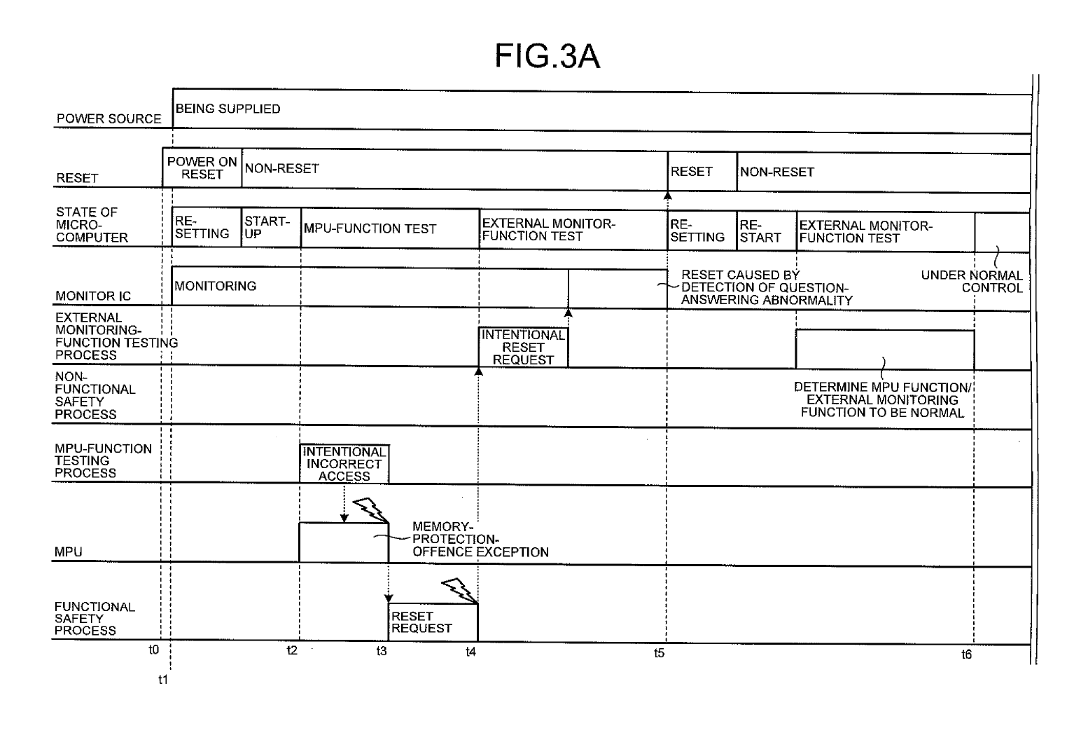

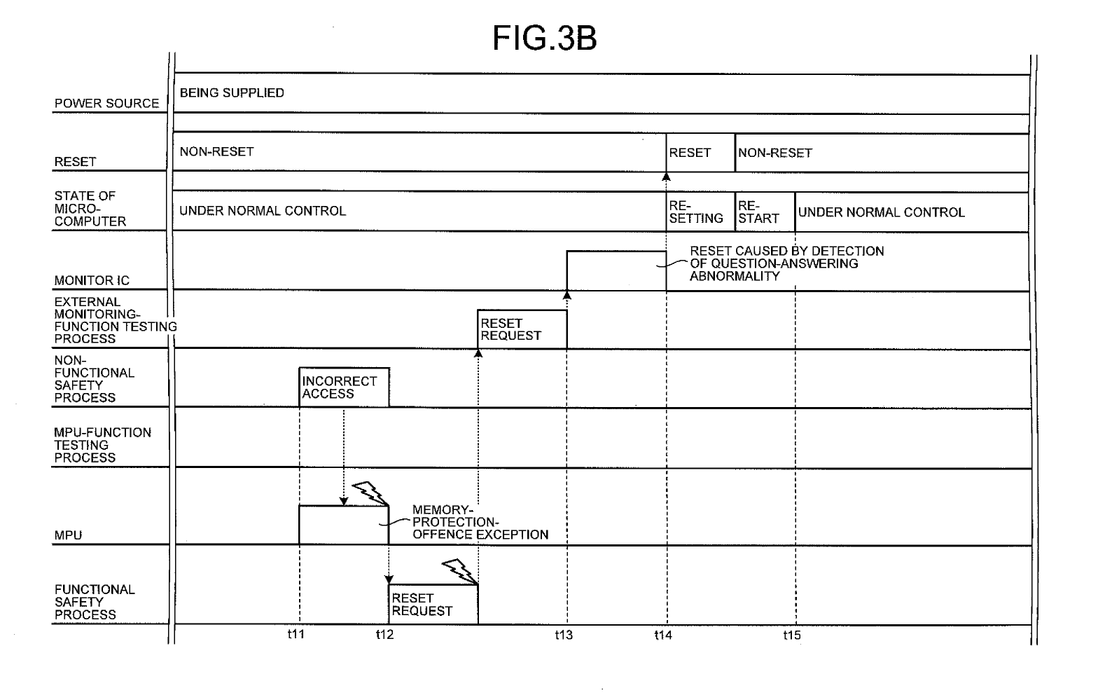

Next, timing diagrams of the function testing method according to the present embodiment will be explained with reference to FIGS. 3A and 3B. FIGS. 3A and 3B are the timing diagrams illustrating the function testing method according to the embodiment.

As illustrated in FIG. 3A, assume that “power-on reset” is performed at a time point t0 and a power source is “being supplied” from a time point t1.

In this case, the monitor IC 12 is turned into a “monitoring” state, and a state of the microcomputer (state of microcomputer 11) is turned into a “start-up” state via “resetting”. After the “start-up” state, the state of the microcomputer is shifted, at a time point t2, to the “MPU-function test” state in advance of the “external monitor-function test”.

In the “MPU-function test” state, an “intentional incorrect access” is executed by an MPU-function testing process of the MPU-function testing unit 11ca. Thus, the MPU 11d generates an interrupt of the “memory-protection-offence exception”.

When receiving this interrupt (see “time point t3”), the functional safety process executed by the functional-safety-process executing unit 11e executes a “reset request” on the external monitoring-function testing process executed by the external monitor-function testing unit 11cb. The external monitoring-function testing process may directly receive the interrupt of the “memory-protection-offence exception”.

When the external monitor-function testing unit 11cb receives the “reset request” (see “time point t4”), a state of the microcomputer is turned into an “external monitor-function test” state, and the external monitor-function testing unit 11cb causes the communication unit 11b to execute an “intentional reset request”. In this case, a test flag (not illustrated) is set to an “under testing” state to be stored in a memory (not illustrated). The test flag is set to an “untested” state when the power source is turned OFF.

When detecting the “intentional reset request”, in other words, an abnormality detected by the question-answering system, the monitor IC 12 resets the microcomputer 11 (see “reset caused by detection of question-answering abnormality” illustrated in FIG. 3A).

Thus, the microcomputer 11 is “reset” at a time point t5 to be turned into “resetting” to “restart” state. In this case, when a test flag is in an “under testing” state, this indicates that a present start-up is an intentional start-up caused by the function test, and the state of the microcomputer is shifted to an “external monitor-function test” state. In this state, the external monitor-function testing unit 11cb “determines MPU function/external monitoring function to be normal” so as to shift, at a time point t6, the microcomputer 11 to an “under normal control” state.

At this time, a test flag is set to a “tested” state. When the test flag is in an “untested” state at a start-up of the microcomputer 11, this indicates that tests of the MPU function and the external monitoring function have not yet been executed, and thus the microcomputer 11 operates from the “MPU-function test” state at the time point t2.

Next, as illustrated in FIG. 3B, assume that, at a time point t11 in an “under normal control” state, a non-functional safety process to be executed by the non-functional-safety-process executing unit 11f executes an “incorrect access”. Thus, the MPU 11d generates an interrupt of a “memory-protection-offence exception”.

When receiving this interruption (see time point t12), the functional safety process to be executed by the functional-safety-process executing unit 11e transmits a “reset request” to the external monitoring-function testing process executed by the external monitor-function testing unit 11cb. The external monitoring-function testing process may directly receive the interrupt of the “memory-protection-offence exception”.

When receiving the “reset request”, the external monitor-function testing unit 11cb causes the communication unit 11b to execute a “reset request” caused by a question-answering abnormality. The monitor IC 12 executes a “reset caused by detection of question-answering abnormality” (see time point t13).

Thus, the microcomputer 11 is “reset” at a time point t14 to be turned into a “resetting” to “restart” state. In this case, when a test flag is in a “tested” state, tests of an MPU function and an external monitoring function have been executed to be determined normal, and thus the microcomputer 11 is shifted to an “under normal control” state at a time point t15.

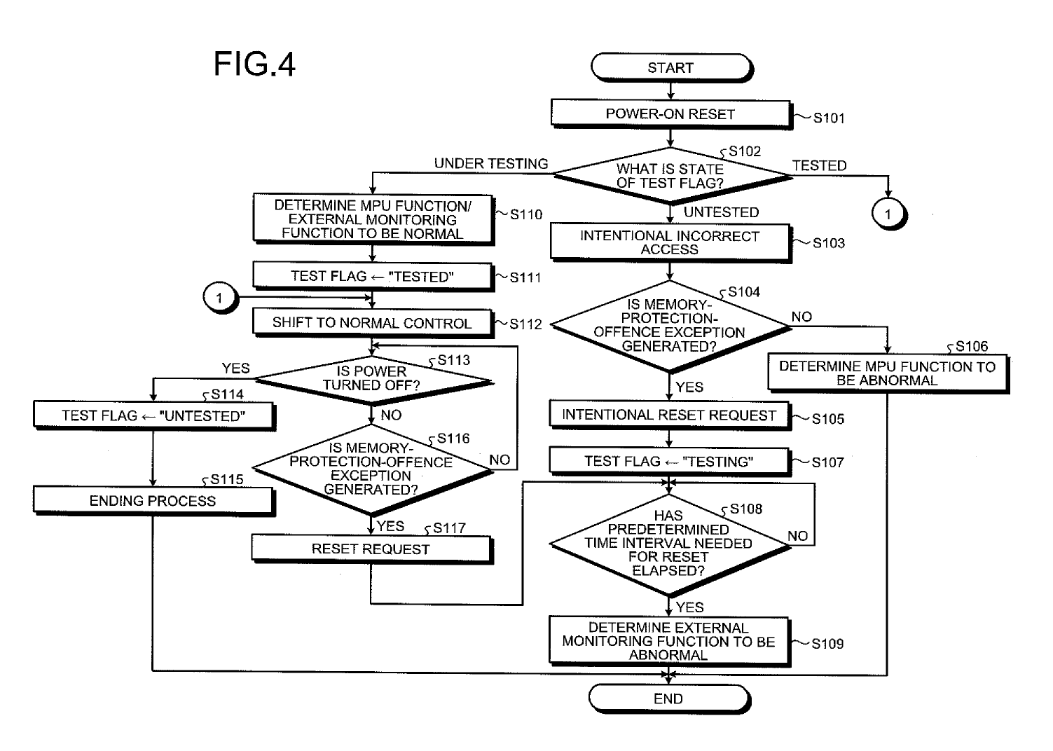

Next, a processing procedure to be executed by the ECU 10 according to the present embodiment will be explained with reference to FIG. 4. FIG. 4 is a flowchart illustrating the processing procedure to be executed by the ECU 10 according to the present embodiment.

As illustrated in FIG. 4, the ECU 10 is power-on reset (Step S101). When the microcomputer 11 is started up, a state of a test flag is determined (Step S102). When the state of the test flag is “untested” (Step S102: untested), the MPU-function testing unit 11ca executes an intentional incorrect access on the protection target region 11g (Step S103).

Next, whether or not a memory-protection-offence exception is generated is determined (Step S104). When the memory-protection-offence exception is generated (Step S104: Yes), the external monitor-function testing unit 11cb executes an intentional reset request on the monitor IC 12 (Step S105).

On the other hand, when a memory-protection-offence exception is not generated (Step S104: No), an MPU function is determined to be abnormal (Step S106), and ends the processing.

Next, after the intentional reset request of Step S105, a test flag is set to an “under testing” state in preparation for a reset (Step S107). Whether or not a predetermined time interval needed for the reset has elapsed is determined (Step S108). The predetermined time interval needed for the reset commonly indicates a time interval needed for restarting the microcomputer 11.

When the predetermined time interval has not elapsed (Step S108: No), the determination of Step S108 is repeated. Herein, if in a normal state, the power-on reset of Step S101 is generated before the predetermined time interval has elapsed, and thus the processes from Step S102 are restarted.

On the other hand, when the predetermined time interval is determined to have elapsed in Step S108 (Step S108: Yes), this means that there does not present a reset caused by an external monitoring function within a predetermined time interval so as to determine the external monitoring function to be abnormal (Step S109), and ends the processing.

Next, when a state of a test flag is “under testing” in Step S102 (Step S102: under testing), this means that the microcomputer 11 is restarted by an intentional reset request in Step S105 so as to determine MPU function/external monitoring function to be normal (Step S110). Next, a test flag is set to a “tested” state (Step S111).

The microcomputer 11 is shifted to a normal control (Step S112). When a power OFF is performed under the normal control (Step S113: Yes), the test flag is set to an “untested” state (Step S114), and an ending process is executed (Step S115) so as to end the processing. In the ending process of Step S115, for example, a process for writing data of an RAM into a flash memory is executed.

When the power OFF is not performed (Step S113: No), whether or not a memory-protection-offence exception is generated under normal control is determined (Step S116).

When the memory-protection-offence exception is not generated (Step S116: No), the processes from Step S113 are repeated. When the memory-protection-offence exception is generated (Step S116: Yes), the external monitor-function testing unit 11cb executes a reset request on the monitor IC 12 (Step S117) so as to shift the processing to Step S108.

As described above, when the predetermined time interval is determined to have elapsed in Step S108 (Step S108: Yes), the external monitoring function is determined to be abnormal (Step S109), and ends the processing. On the other hand, a power-on reset is normally performed before the predetermined time interval has elapsed (Step S101), the processes from Step S102 are restarted.

When a test flag is in a “tested” state in Step S102 (Step S102: tested), this means that the microcomputer 11 is restarted by the reset request of Step S117 that is based on a generation of the memory-protection-offence exception under normal control. Therefore, in this case, the tests of the MPU function and the external monitoring function are ended, and thus the microcomputer 11 is shifted to a normal control (Step S112).

As described above, the ECU 10 (one example of “controller”) according to the present embodiment includes the microcomputer 11 (one example of “main processing unit”) and the monitor IC 12 (one example of “monitoring unit”). The microcomputer 11 executes a program. The monitor IC 12 monitors a signal, output from the microcomputer 11, so as to reset the microcomputer 11 when detecting an abnormality in the microcomputer 11. The microcomputer 11 includes the MPU 11d (one example of “detection unit”), the MPU-function testing unit 11ca (one example of “first testing unit”), and the external monitor-function testing unit 11cb (one example of “second testing unit”). The MPU 11d resets, when detecting an incorrect access, the microcomputer 11. The incorrect access is an access, to the protection target region 11g that is dedicated to a functional-safety application (one example of “specific program”), of a non-functional-safety application (one example of “another program other than specific program”). The MPU-function testing unit 11ca intentionally executes the incorrect access to the protection target region 11g so as to test whether or not the microcomputer 11 is reset by the MPU 11d. The external monitor-function testing unit 11cb intentionally outputs a signal indicating an abnormal state to the monitor IC 12 so as to test whether or not the microcomputer 11 is reset by the monitor IC 12. When detecting the incorrect access, the MPU 11d causes the external monitor-function testing unit 11cb to intentionally output, to the monitor IC 12, a signal indicating an abnormal state.

Thus, by employing the ECU 10 according to the present embodiment, it is possible to improve the reliability of the function test so as to enhance the safety.

The microcomputer 11 causes the external monitor-function testing unit 11cb to execute a test, and then further causes the MPU-function testing unit 11ca to execute a test.

Thus, by employing the ECU 10 according to the present embodiment, “MPU-function test” and “external monitor-function test” are able to be performed only by executing one reset, so that it is possible to shorten a time interval for the ECU 10 to shift from a power ON to a normal control.

In the above-mentioned embodiment, the ECU 10 is explained to be provided in the vehicle C; however, not limited to the vehicle C, the ECU 10 may be provided in a ship, an airplane, and the like. Moreover, the ECU 10 may be employed as a controller of not only such movable machines, but also a machine that is placed and used in a fixed position.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A controller comprising:
a main processing unit that executes a program; and
a monitoring unit that monitors a signal, output from the main processing unit, so as to reset the main processing unit when detecting an abnormality in the main processing unit, wherein
the main processing unit includes:
a detection unit that resets, when detecting an incorrect access, the main processing unit, the incorrect access being an access, to a protection target region that is dedicated to a specific program, of another program other than the specific program;
a first testing unit that intentionally executes the incorrect access to the protection target region so as to test whether or not the main processing unit is reset by the detection unit; and
a second testing unit that intentionally outputs a signal indicating an abnormal state to the monitoring unit so as to test whether or not the main processing unit is reset by the monitoring unit, and
when detecting the incorrect access, the detection unit causes the second testing unit to intentionally output, to the monitoring unit, a signal indicating an abnormal state.

2. The controller according to claim 1, wherein
the main processing unit causes the second testing unit to execute a test, and then further causes the first testing unit to execute a test.

3. A function testing method to be executed by a controller including a main processing unit that executes a program and a monitoring unit that monitors a signal, output from the main processing unit, so as to reset the main processing unit when detecting an abnormality in the main processing unit, the method comprising:
resetting the main processing unit when detecting an incorrect access that is an access, to a protection target region that is dedicated to a specific program, of another program other than the specific program;
intentionally executing the incorrect access to the protection target region so as to test whether or not the main processing unit is reset in the resetting; and
intentionally outputting a signal indicating an abnormal state to the monitoring unit so as to test whether or not the main processing unit is reset by the monitoring unit, wherein
the intentionally outputting includes intentionally outputting a signal indicating an abnormal state to the monitoring unit when the incorrect access is detected in the resetting.
